(19) United States
(12) Patent Application Publication
(10) Pub. No.: US 2025/0080564 A1
(43) Pub. Date: Mar. 6, 2025

(54) VULNERABILITY MANAGEMENT BASED ON NETWORK INFRASTRUCTURE SECURITY CONTEXT

(71) Applicant: Cisco Technology, Inc., San Jose, CA (US)

(72) Inventors: Robert Edgar Barton, Richmond (CA); Bhavik Pradeep Shah, Parangipalya (IN); Indermeet Singh Gandhi, San Jose, CA (US); Jerome Henry, Pittsboro, NC (US)

(21) Appl. No.: 18/460,786

(22) Filed: Sep. 5, 2023

(51) Int. Cl. H04L 9/40

(52) U.S. Cl. CPC H04L 63/1433; H04L 63/1416; H04L 63/20

(57) ABSTRACT

Provided herein are techniques to facilitate vulnerability management for one or more endpoint devices of a network based on network infrastructure security context. In one example, a computer-implemented method may include determining a base vulnerability score for a particular vulnerability that is detected for an endpoint device of an enterprise network; determining topology information for the endpoint device within the enterprise network; translating the particular vulnerability to triggering information; performing a comparison between the security policies for the one or more network security mechanisms of network security infrastructure and the triggering information to determine whether the endpoint device is protected from the particular vulnerability being triggered for the endpoint device; and generating an updated vulnerability score for the particular vulnerability by adjusting the base vulnerability score based on whether the endpoint device is protected from the particular vulnerability being triggered for the endpoint device.

### TECHNICAL FIELD

The present disclosure relates to network equipment and services.

### BACKGROUND

In network environments, network nodes are often vulnerable to network threats, such as viruses, exploits, or the like. A security operations team or system typically operates to protect nodes of a network operated by an entity or organization. As networks grow and become more complex, efficient management of network threats becomes more critical.

### BRIEF DESCRIPTION OF THE DRAWINGS

FIG. 1 is a block diagram of a system that may be utilized to provide vulnerability management for a network based on network infrastructure security context, according to an example embodiment.

FIG. 2 is a block diagram illustrating example operations that may be performed via a vulnerability management system in order to facilitate vulnerability management based on network infrastructure security context, according to an example embodiment.

FIG. 3 is a flowchart depicting a method according to an example embodiment.

FIG. 4 is a hardware block diagram of a computing device that may perform functions associated with any combination of operations discussed in connection with techniques described for embodiments herein.

### DETAILED DESCRIPTION

### Overview

Current systems that provide vulnerability scores for detected vulnerabilities of endpoint devices only consider an endpoint or system itself (e.g., operating system (OS), patch level, etc.) in light of potential vulnerabilities or threats, but not network security elements that may be able to protect the endpoints or, stated differently, that may protect a detected vulnerability from being triggered for an endpoint.

Embodiments herein extend the concept of vulnerability management to include security policies (interchangeably referred to herein as security controls) in place for network security infrastructure mechanisms that may be provided/configured to prevent a detected vulnerability for an endpoint from being triggered for the endpoint. In accordance with embodiments herein, a network architecture is provided through which a vulnerability management system can operate to determine how endpoints may be protected by a network security infrastructure such that relative vulnerability scores for detected vulnerabilities of the endpoint devices can be altered or augmented to account for network security infrastructure that may be capable of protecting the endpoints/preventing the detected vulnerabilities from being triggered for the endpoints.

In at least one embodiment, a computer-implemented method is provided that may include determining a base vulnerability score for a particular vulnerability that is detected for an endpoint device of an enterprise network; determining topology information for the endpoint device within the enterprise network, wherein the topology information indicates one or more network security mechanisms of a network security infrastructure of the enterprise network that are capable of preventing the particular vulnerability from being triggered for the endpoint device; translating the particular vulnerability to triggering information that identifies mechanisms through which to trigger the particular vulnerability for the endpoint device; obtaining security policies for the one or more network security mechanisms of the network security infrastructure that are to potentially protect the endpoint device from vulnerabilities; performing a comparison between the security policies for the one or more network security mechanisms of the network security infrastructure and the triggering information to determine whether the endpoint device is protected from the particular vulnerability being triggered for the endpoint device; and generating an updated vulnerability score for the particular vulnerability that is detected for the endpoint device by adjusting the base vulnerability score based on whether the endpoint device is protected from the particular vulnerability being triggered for the endpoint device.

### Example Embodiments

Conventional vulnerability management systems, with the help of third-party intelligence sources, are often used to determine the relative risk posed by a known network ‘threat’ to a vulnerable (unpatched) host. Generally, a network threat or information pertaining thereto can be represented in the form of a Common Vulnerability Scoring System (CVSS) score or an Exploit Prediction Scoring System (EPSS) score that can be provided to a security operations (SecOps) team for an organization or entity that manages the organization's network so that the SecOps team can determine the highest priority devices of the network to patch.

Vulnerability management systems today typically use network scanning data to learn properties of the network endpoints and hosts to determine if they are vulnerable. In some instances, threat information combined with threat intelligence can be applied against an artificial intelligence (AI)/machine learning (ML) classification engine to determine the relative vulnerability of a device, which can culminate in calculating a CVSS/EPSS score for the device.

Thus, most conventional vulnerability management techniques examine information solely about an endpoint, which can be gathered through a scanner, an endpoint agent or any other technique as may be known in the art, and then then evaluated (e.g., using an AI/ML model) to determine a relevance of the risk in light of known threats. The result is a CVSS/EPSS score which helps administrators know for which discovered potential vulnerability hosts need to be patched first (highest CVSS score to lowest).

One limitation of this approach is that current vulnerability management systems do not take into account an infrastructure's ability to defend against a known attack. In modern networks, traffic to or from a host must go through multiple layers of security infrastructure elements, including firewalls, intrusion prevention systems, etc., which can increase with secure service edge (SSE) and secure access service edge (SASE) network implementations. Thus, current vulnerability systems lack an understanding regarding the ability of an infrastructure to prevent attacks.

To make vulnerability management more meaningful, it would be advantageous for a vulnerability management system take into consideration the surrounding security controls of a network when determining vulnerabilities of network endpoints. For example, if a host is theoretically vulnerable, but network security infrastructure has the ability to protect the host, the relative vulnerability score describing this device can be adjusted.

In accordance with embodiments herein, a vulnerability management system can be augmented to consider network security infrastructure information in order to determine a more meaningful and contextually accurate vulnerability score (e.g., an augmented CVSS score and/or an augmented EPSS score) for one or more endpoint devices of a network in which such contextually accurate vulnerability scores can be used be SecOps teams to manage network security and/or vulnerabilities of endpoint devices in a network.

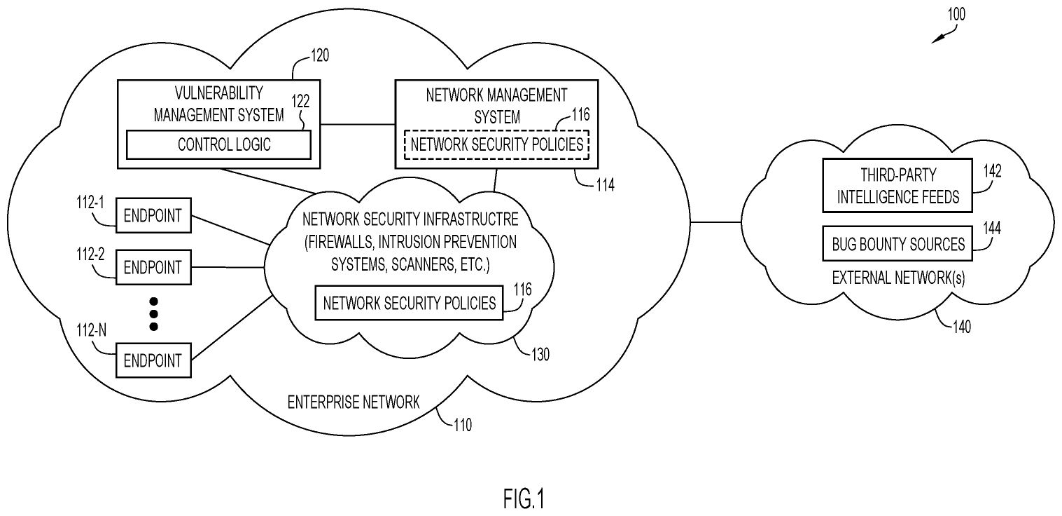

Referring to FIG. 1. FIG. 1 is a block diagram of a system 100 that may be provided to facilitate vulnerability management for one or more endpoints of a network based on network infrastructure security context, according to an example embodiment. In at least one embodiment, system 100 may include an enterprise network 110 and one or more external network(s) 140. In at least one embodiment, enterprise network 110 may include any number of hosts or endpoint devices, such as endpoints 112-1, 112-2 thru 112-N, a vulnerability management system 120, and network security infrastructure 130. Enterprise network 110 may further include a network management system 114 that may operate to facilitate management, configuration, operation, etc. of elements, devices, etc. of enterprise network 110, including, but not limited to endpoints 112-1-112-N, any elements, devices, functions, etc. that may be provided via network security infrastructure 130. Vulnerability management system 120 may include control logic 122 which may perform various operations in accordance with embodiments herein in order to facilitate vulnerability management for enterprise network 110 based on network security infrastructure 130 context, as discussed in further detail herein.

Although not shown in FIG. 1, network security infrastructure 130 can include any combination of firewalls, intrusion prevention systems, network scanners, and/or any other network security infrastructure elements, devices, etc. as may be understood in the art. It is to be understood that network scanners may also be provided via vulnerability management system 120 in some embodiments such that any combination of networks scanners that may be provided via network security infrastructure 130 and/or vulnerability management system 120 may operate in any manner as may be understood in the art in order to detect and report exploits, vulnerabilities, or the like (collectively referred to herein as ‘vulnerabilities’) that may impact and/or otherwise affect the operation of one or more of endpoints 112-1-112-N.

In at least one embodiment, elements, devices, etc. provided for network security infrastructure can be configured with network security policies 116 (e.g., via network management system 114. In at least one embodiment, network management system 114 can be configured with or otherwise include various network security policies 116 that can be used to configure, manage, or otherwise operate network security infrastructure 130 via such policies.

Enterprise network 110 may be inclusive of any combination of cloud network(s), wide area network(s) (WAN(s)) (including software defined WAN(s)), local area networks (including any combination of wired local area network(s) and/or wireless local area network(s)), Ethernet network(s)/switching system(s), and/or the like that may be managed, controlled, and/or otherwise operated by an enterprise entity (e.g., a business entity, a government entity, an education entity, etc.) to serve enterprise purposes.

External network(s) 140 may be inclusive of any cloud networks, the public internet, and/or any other network that may be considered external to or not managed by network management system 114 and/or any other network control element of enterprise network 110. In various embodiments, external network(s) 140 may include third-party intelligence feeds 142 and bug bounty sources 144 from which vulnerability management system 120 may receive or otherwise obtain vulnerability information regarding various vulnerabilities that may impact one or more of endpoints 112-1-112-N of enterprise network 110.

In various embodiments, endpoints 112-1-112-N may be implemented as any combination of wired and/or wireless computing device, user equipment (UE), and/or the like that may operate via enterprise network 110. In some instances, endpoints 112-1-112-N may be associated with and/or operated by a user. As referred to herein, an endpoint can be referred to interchangeably as an endpoint device, a host, and/or variations thereof.

Various connections/interfaces among various elements of FIG. 1 are provided for illustrative purposes only and are not meant to limit the broad scope of embodiments herein. It is to be understood that each of the elements of FIG. 1 may interface and/or otherwise be connected in any manner to facilitate any operations as discussed for embodiments herein.

Broadly during operation of system 100, vulnerability management system 120 may utilize network security infrastructure 130 knowledge, as may be determined, for example, from various network security policies 116 configured for enterprise network 110 in order to augment or adjust risk scoring of potential vulnerabilities that may be associated with endpoints 112-1-112-N.

For example, vulnerability management system 120, via control logic 122, may operate to evaluate the risk of a vulnerability by taking consideration not just the posture of an endpoint, such as endpoint 112-1, but rather, the ability of the network security infrastructure 130 and one or more network security mechanisms that may be provided by/configured for the network security infrastructure 130 (or, more generally, network security context) to protect the endpoint 112-1 in order to adjust a base vulnerability score (e.g., CVSS or EPSS score) calculated for the vulnerability.

Thus, during operation, vulnerability management system 120 may operate to correlate each of one or more exploits or vulnerabilities not only the endpoint scanning data, but also with network security infrastructure 130 security controls and policies, such as network security policies 116, such that a more accurate vulnerability score (e.g., CVSS or EPSS score) can be generated and evaluated for endpoints 112-1-112-N, allowing administrators organize the patching sequence based on the risk for the endpoints 112-1-112-N, not as devices in a vacuum, but as devices protected by network security infrastructure 130.

For example, if it is determined that network security policies 116 implemented via network security infrastructure 130 inherently have the ability or capability to filter/prevent a vulnerability or attack such as a Log4j attack through an intrusion prevention system (IPS), then the CVSS or EPSS risk score for endpoints that may potentially be vulnerable to such an attack can be automatically adjusted, such as being reduced, via network management system 120, as these hosts would not be directly vulnerable given the context of network security infrastructure 130 to prevent such an attack.

Accordingly, based on the topology and calculated paths to various endpoints, a determination can be made what types of security measures are protecting each endpoint of enterprise network 110 that may have a detected vulnerability. In some instances, this may include an examination of the actual firewall and DPI rules to determine if they are capable of protecting hosts against a known threat. For example, if an exploit uses a well-known open port on a host, the vulnerability management system 120 can determine if a security device in front of the host provided via network security infrastructure 130 allows or denies access to this port.

In another example, an IPS may be deployed via network security infrastructure 130 that already protects against the specific threat. In this case, the vulnerability management system 120 would have access to the IPS rules and can determine if a rule protecting against the threat is enabled or not. In yet another example, if the attack uses windows networking ports (port number 445), but a firewall in front of a host is blocking this host, or a specific DPI rule is in place to detect the known threat, the vulnerability management system 120 can determine that a base vulnerability rating or score against the host can be lowered.

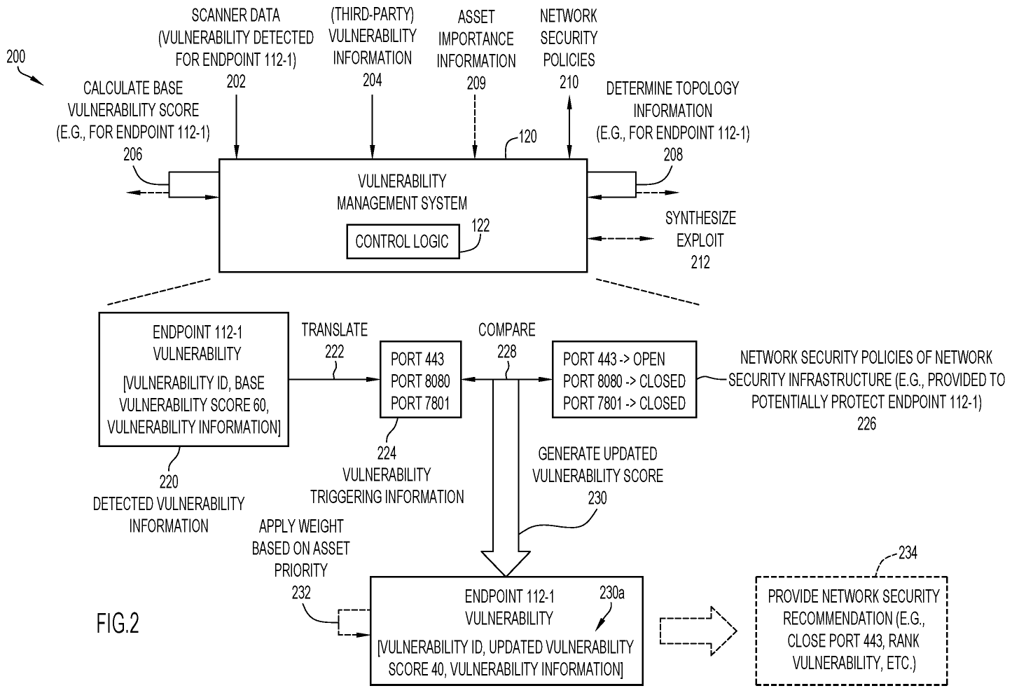

In at least one embodiment, once an examination is performed by vulnerability management system 120 regarding a detected vulnerability for a particular endpoint, if it is determined the network security services/policies of network security infrastructure 130 provide a measure of protection to the threat, a current or base vulnerability score for the detected vulnerability for the particular endpoint may be lowered in proportion to the protection being offered. Other variations and operations can be envisioned, as discussed in further detail, below with regard to FIG. 2

Referring to FIG. 2, FIG. 2 is a block diagram 200 illustrating example operations that may be performed via a vulnerability management system, such as vulnerability management system 120 of FIG. 1, in order to facilitate vulnerability management based on network infrastructure security context, according to an example embodiment.

For example, during operation vulnerability management system 120 may operate to ingest or otherwise obtain scanner data, as generally shown at 202 of FIG. 2, that may identify detected vulnerabilities that may compromise or otherwise impact the operation of endpoints 112-1-112-N. Such scanner data can be generated using any techniques as understood in the art and/or hereinafter developed. As noted above, any combination of networks scanners that may be provided via network security infrastructure 130 and/or vulnerability management system 120 may operate in any manner as may be understood in the art in order to detect and report vulnerabilities that may impact and/or otherwise affect the operation of one or more of endpoints 112-1-112-N.

As shown at 204, vulnerability management system 120 may also ingest various vulnerability information regarding network vulnerabilities that may comprise or otherwise impact the operation of endpoints 112-1-112-N. For example, in at least one embodiment, vulnerability information including a threat intelligence feed from third-party open sources, such as third-party intelligence feed 142, can be ingested by the vulnerability management system 120, as generally shown at 202. In some embodiments, vulnerability information such as bug bounty information that may be obtained from bug bounty sources 144 can also be ingested by the vulnerability management system 120. In at least one embodiment, third-party sources of vulnerability information may include the Common Vulnerabilities and Exposures (CVE®) database and other security vendor databases. CVE® is a registered trademark of The MITRE Corporation.

Vulnerability information ingested by vulnerability management system can include any combination of vulnerability documents, digests, such as software bill of materials (SBOM) documents, Vulnerability Exploitability Exchange (VEX) documents, and/or the like.

Generally, SBOM documents are machine-readable documents, files, or data structures that identify or otherwise provide an inventory of components, functions, libraries, etc. that may be utilized by software/applications. In some instances, SBOMs can identify vulnerabilities of elements identified in an SBOM. Generally, VEX documents are machine-readable SBOM companion documents, files, or data structures that can provide more detailed vulnerability information for various software/applications/etc. Thus, SBOM and VEX documents can be ingested and utilized by security management tools, software, logic, etc. in order to identify/manage vulnerabilities for software/applications/etc.

As shown at 206, current or base vulnerability score can be determined by vulnerability management system 120 for any endpoints 112-1-112-N that may have detected vulnerabilities using any techniques as understood in the art and/or hereinafter developed, such as through AI/ML classification techniques, or the like based on the vulnerability information and scanner data ingested by the vulnerability management system 120. For the embodiment of FIG. 2, consider that a vulnerability is detected (e.g., from scanner data obtained by vulnerability management system 120) and a base vulnerability score for the particular vulnerability detected for endpoint 112-1 is calculated by vulnerability management system 120, via control logic 122, as generally shown at 210. For the present example, consider that vulnerability management system 120 calculates a base vulnerability score of ‘60’ for the vulnerability detected for endpoint 112-1.

Vulnerability management system 120 can maintain detected vulnerability information for each vulnerability detected for each endpoint 112-1-112-N for which one or more vulnerabilities may be detected. For example, as shown at 220, vulnerability management system 120 can maintain or otherwise store detected vulnerability information for endpoint 112-1 for which a vulnerability has been detected (for the present example). In various embodiments detected vulnerability information stored for an endpoint can include, for each of one or more vulnerabilities detected for the endpoint, each of: an identifier for a particular vulnerability detected for the endpoint, a base vulnerability score calculated for the detected vulnerability, and vulnerability information that may describe or otherwise characterize the vulnerability (e.g., as obtained from third-party sources, via SBOM/VEX documents, etc.). It is to be understood that other detected vulnerability information may be stored for an endpoint. For example, in some embodiments, topology information for an endpoint can also be stored/maintained by the vulnerability management system 120 based on one or more topology discovery processes, as discussed in further detail, below.

When a vulnerability is detected for on a host/endpoint, such as endpoint 112-1, the vulnerability management system 120 indexes all security policies that are applied to this host/endpoint in its path from the edge (e.g., interconnections with external network(s) 140), through the various perimeter security devices, and emerging into a cloud or other destination. In at least one embodiment, such indexing may include obtaining or otherwise determining topology information regarding potential attack paths that may be utilized to trigger vulnerabilities for endpoints, as generally shown at 208 (e.g., for determining topology information regarding endpoint 112-1).

In at least one embodiment, such topology information can be determined by performing topology discovery of the enterprise network 110 and network security infrastructure 130 in order to pinpoint various network-level security controls, such as firewalls, next generation (NG) firewalls, IPS, or other security mechanisms that may be provided via network security infrastructure to potentially protect endpoints from vulnerabilities that may be triggered on the endpoints. In some instances, such topology discovery and information determined therefrom can include determining endpoint detection and response logic that may be provided on endpoints.

In various embodiments, network topology discovery can be performed by vulnerability management system 120 or any element, function, etc. of enterprise network 110, network management system 114, and/or network security infrastructure 130 utilizing any techniques as understood in the art and/or hereinafter developed. As part of the topology discovery, the vulnerability management system 120 can analyze potential attack paths leading to each endpoint 112-1-112-N in order to identify mechanisms of network security infrastructure 130 that are provided to potentially prevent vulnerabilities from being triggered on the endpoints or stated differently, that have the ability or capability to prevent (if configured correctly) vulnerabilities from being triggered on the endpoints.

For example, attack paths could originate from a less secure network (e.g., the Internet), a cloud service, etc. In some embodiments, vulnerability management system 120 may utilize an application programming interface (API) or the like to perform topology discovery of enterprise network 110, endpoints 112-112-N, and network security infrastructure 130. In some embodiments, topology information for enterprise network 110 may be maintained by network management system 114, which can be queried by vulnerability management system 120 in order to obtain/determine such topology information. Thus, topology information determined by vulnerability information may indicate one or more security mechanisms (e.g., firewalls, intrusion prevention systems, etc.) of network security infrastructure 130 that have the ability or capability to prevent vulnerabilities from being triggered for the endpoints, such as endpoint 112-1 for which the vulnerability is detected.

Based on the detected vulnerability information maintained for an endpoint, such as endpoint 112-1, as shown at 220 for the present example, vulnerability management system 120 can perform a translation process, as generally illustrated at 222, in order to translate the particular detected vulnerability for endpoint 112-1 into vulnerability triggering information, as generally shown at 224, which may represent network infrastructure exploits or mechanisms through which the detected vulnerability can be triggered to execute or otherwise operate via endpoint 112-1. For example, as shown at 224, it may be determined by vulnerability management system 120 (e.g., based on the vulnerability information obtained from third-party sources, etc.) that the detected vulnerability for endpoint 112-1 can be triggered through one or more of port numbers 443, 8080, and/or 7801, by way of example only.

In various embodiments, vulnerability triggering information determined for a detected vulnerability can include any combination of infrastructure exploits, such as one or more port numbers, one or more Internet Protocol (IP) addresses, etc., application exploits, such as API calls, function calls, etc., and/or any other mechanism through which a detected vulnerability could be triggered for an endpoint.

In accordance with embodiments herein, the vulnerability management system 120 is augmented to examine the network security controls and/or policies in place for network security infrastructure 130 (e.g., in place on the perimeter, via an SASE cloud, and/or other associated infrastructure in the path of the hosts/endpoints) via network security policies 116 that may be provided for the security mechanisms of the network security infrastructure 130 in order to protect the triggering of vulnerabilities detected for the endpoints, such as endpoint 112-1. For example, network security policies 116 can identify and examine security controls (e.g., access control lists (ACLs), IPS policies, etc.) configured on security devices of the network security infrastructure 130, such as firewalls, IPS devices, cloud access security broker (CASB) devices, and, in some instances can also examines network segmentation or slices for enterprise network 110.

Such examination performed by vulnerability management system 120 could, in at least one embodiment, include processing and analyzing ACLs, Layer 3 (L3) and/or Layer 4 (L4) firewall rules, deep-packet inspection policies, and others that may be applied to different parts of the enterprise network 110/network security infrastructure 130 in relation to endpoints 112-1-112-N.

In at least one embodiment, vulnerability management system 120 may utilize one or more API(s) to query security mechanisms (e.g., devices, functions, etc.) of network security infrastructure 130 in order to obtain network security policies 116 directly from security mechanisms of the network security infrastructure that may be in the path of one or more of endpoints 112-1-112-N, such as endpoint 112-1 (having the detected vulnerability in this example), as determined from the topology information, as generally shown at 210. Vulnerability management systems can process mass amounts of data from scanners; thus, the load added from examining security policies may be incremental. For example, based on the topology information for endpoint 112-1 determined at 208, vulnerability information could query security mechanisms provided via network security infrastructure 130 along potential attack paths in order to obtain network security policies 116 from the security mechanisms.

It is to be understood that network security policies 116 may be obtained by vulnerability management system 120 from other sources within enterprise network 110. For example, in at least one embodiment, network security policies 116 may be maintained by network management system 114 for the different security mechanisms provided via network security infrastructure 130 such that vulnerability management system 120, upon identifying (via the topology information determined at for endpoint 112-1 at 208) the relevant mechanisms of the network security infrastructure 130 that have the ability or capability to prevent the particular vulnerability from being triggered for the endpoint 112-1, can query the network management system 114 to obtain the network security policies of the identified security mechanisms. Other variations for obtaining/determining network security policies 116 by vulnerability management system 120 can be envisioned.

For the present example, vulnerability management system 120 can, based on the topology information determined for endpoint 112-1 at 208 and the network security policies 116 obtained at 210, determine the network security policies or rules configured for the network security infrastructure that are provided to potentially protect the endpoint from one or more vulnerabilities, as generally shown at 226, but which may or may not actually protect the endpoint 112-1 from the particular detected vulnerability, as discussed in further detail, below. As shown in FIG. 2, consider for the present example that vulnerability management system 120 determines that port number 443 is open, port number 8080 is closed, and port number 7801 is closed via one or more security mechanisms provided via network security infrastructure 130.

The vulnerability management system 120 can determine the exposure to the threat/detected vulnerability for the endpoint 112-1 based on the vulnerability triggering information (224) determined for the vulnerability detected for endpoint 112-1, the possible data/attack paths for the detected vulnerability, and the network security policies 116 of the security elements/mechanisms of network security infrastructure 130 on the path of the endpoint 112-1 (226) such that, based on the exposure to the threat/detected vulnerability, the vulnerability management system 120 can adjust the base vulnerability score for the detected vulnerability for the endpoint 112-1 based on the context of network security infrastructure 130 or, stated differently, can adjust the base vulnerability score based on the ability of the network security infrastructure 130 to protect the endpoint 112-1 from the threat/detected vulnerability.

For example, as shown at 228, vulnerability management system 120 can perform a mapping or comparison between the vulnerability triggering information (224) and the network security policies or rules (226) configured for the network security infrastructure that are provided to potentially protect the endpoint from one or more vulnerabilities in order to determine whether the endpoint 112-1 is protected from the detected vulnerability being triggered for the endpoint 112-1.

Based on the comparison, vulnerability management system 120 can generate an updated vulnerability score for the particular vulnerability detected for endpoint 112-1, as generally shown at 230, by adjusting the base vulnerability score based on whether the endpoint 112-1 is protected from the particular vulnerability being triggered for the endpoint 112-1. For example, if it is discovered that security policies exist that would naturally protect against the recorded vulnerability for any path to the endpoint 112-1, the vulnerability score (e.g., CVSS score, EPSS score, etc.) given to this threat on the endpoint 112-1 can be adjusted downward to indicate a less vulnerable state of the endpoint 112-1.

For the present example, for instance, based on the comparison at 228, vulnerability management system 120 can determine that only port number 443 is open, while port numbers 8080 and 7801 are closed based on network security policies provided for the security mechanisms of network security infrastructure 130. Thus, the base vulnerability score calculated for the vulnerability detected for endpoint 112-1, the value/score of ‘60’ in this example, may be decreased based on the determination that two of the three (2/3) mechanisms through which the detected vulnerability may be triggered on endpoint 112-1 are prevented by network security policies configured for the security mechanisms provided via network security infrastructure 130.

By way of example only, the vulnerability management system 120 may generate the updated vulnerability score (e.g., at 230) by reducing the base vulnerability score by approximately 2/3 (as the endpoint 112-1 is protected from two of the potential exploits of the detected vulnerability being triggered) in order to generate an updated vulnerability score of 40 (e.g., 2/3*60=39.6 or rounded up to 40), which can be updated/stored for the detected vulnerability information for endpoint 112-1, as generally shown at 230a. Thus, in some instances, a base vulnerability score calculated for a detected vulnerability for an endpoint can be adjusted (e.g., lowered) in proportion to the protection being offered via network security infrastructure 130 to prevent the detected vulnerability from being triggered on the endpoint.

Conversely, if less than a majority of available protections or no available protections are being provided by network security infrastructure, a base vulnerability score could be adjusted to be increased by a proportional or set amount. For example, if it is determined that the network security infrastructure only protects against 1/3 of potential triggering mechanisms for a detected vulnerability, an updated vulnerability score for the detected vulnerability score could be increased by 1/3 (e.g., increased from 60 to 80 for the present example), could be increased by a set or fixed amount, or in some embodiments, could remain unchanged from the base vulnerability score. depending on system configuration.

In some instances, both a base vulnerability score for a detected vulnerability for an endpoint and an updated vulnerability score for the detected vulnerability for the endpoint may be maintained in vulnerability information stored for a detected vulnerability for the endpoint (e.g., for comparison purposes, for managing and/or learning appropriate amount(s) of decreasing/increasing base vulnerability scores based on different infrastructure security mechanisms that may/may not be in place for a given network, combinations thereof, and/or the like).

It is to be understood that the examples discussed above for decreasing or increasing a base vulnerability score to generate an updated vulnerability score are provided for illustrative purposes only and are not meant to limit the broad scope of the teachings of embodiments herein. Different variations could be envisioned for generating an updated vulnerability score for a vulnerability detected for an endpoint in accordance with the teachings of the present disclosure.

Thus, broadly, the vulnerability management system 120 can determine the topology of the enterprise network 110 and network security infrastructure 130 such that it can be determined where endpoints are connected to enterprise network 110, what they are connected to, and any security services/mechanisms that may be protecting the endpoints via network security infrastructure 130 (e.g., which NG firewalls, IPS rules, etc. are protecting endpoints) such that a vulnerability score for endpoints can be adjusted in accordance with the determined network infrastructure security context.

Accordingly, embodiments herein may provide a tuning mechanism through which the vulnerability score of endpoints may be adjusted on a per-device basis based on analysis how network security infrastructure 130 and network security policies 116 are performing to remove or reduce threat(s) to endpoints.

For example, if the network security infrastructure 130 is not able to provide any additional protection, the base or current vulnerability score for a detected vulnerability for an endpoint may be increased or, in some instances, may remain unchanged or the same.

However, if the infrastructure is providing protection against a known threat, the vulnerability score may be lowered accordingly, which may, in some instances, be used to indicate that patching or addressing the vulnerability may be a lower priority for addressing by a SecOps team.

Thus, per-host/endpoint vulnerability scores can be augmented in accordance with embodiments herein based on the added dimension of knowledge pertaining to the ability of the underlying network security infrastructure 130 and network security policies 116 to protect such hosts/endpoints.

In addition to the consideration of security mechanisms of network security infrastructure 130 that may be provided/configured to prevent a detected vulnerability from being triggered for an endpoint in order to generate an updated vulnerability score, in at least one embodiment, vulnerability management system 120 may consider asset (endpoint) importance or priority in adjusting vulnerability scores for endpoints 112-1-112-N.

For example, in at least one embodiment, as shown at 209, vulnerability management system 120 may obtain asset importance information that may indicate a priority or other indication that identifies an importance of endpoints 112-1-112-N in which vulnerability management system 120 may further adjust the updated vulnerability score for an endpoint having a detected vulnerability, such as endpoint 112-1, based on the importance of the endpoint 112-1.

For example, as generally shown at 232, in at least one embodiment, vulnerability management system 120 may apply a weight to the (first) updated vulnerability score based on a priority or other value indicative of an importance of endpoint 112-1 in order to generate another (second) updated vulnerability score for the particular vulnerability that is detected for the endpoint 112-1. In one instance, if the endpoint 112-1 is a more important asset for enterprise network 110, the updated vulnerability score could be increased in proportion to the weight for the asset (e.g., indicating a higher priority for patching or addressing the detected vulnerability for the endpoint). Conversely, if the endpoint is a less important asset for enterprise network 110, the updated vulnerability score could be decreased in proportion to the weight of for the asset (e.g., indicating a lower priority for patching or addressing the detected vulnerability for the endpoint). In at least one embodiment, asset importance information for endpoints 112-1-112-N can be obtained from network management system 114.

Beyond determining topology information regarding a particular endpoint for which a particular vulnerability is detected and determining security policies/security mechanisms of network security infrastructure 130 that may prevent the particular vulnerability from being triggered, in some embodiments, the vulnerability management system 120 may synthesize an exploit, such as synthesizing a packet flow via enterprise network 110/network security infrastructure 130 that imitates the form and nature of an attack to determine if the enterprise network 110 has a natural defense against the vulnerability, as generally shown at 212. For example, if an application in the network has a known and unpatched API vulnerability, the vulnerability management system 120 may open an API call to that application with the express intent of determining if there are existing security controls that prevent exploit of this vulnerability. As results are learned from the synthetic security probe through the network and the network's ability to prevent the exploit are learned, a vulnerability score for the endpoint can be adjusted accordingly.

In at least one embodiment, the enterprise network 110 may have various automated pen-testing tools deployed such that through an extended detection and response (XDR) system if it is found that a network device can protect a host against a certain type of attack, the vulnerability score of an endpoint may be lowered.

In at least one embodiment, a vulnerability score for a detected vulnerability for an endpoint can be displayed to a network administrator in combination with any contributing elements that may impact adjustment of the score (e.g., the score can be displayed at a medium level because packet filter ABC is on the path and will block the connection associated with vulnerability X from outside enterprise network or an indication can be provided that the score would increase to a high level if packet filter ABC were to be removed, or the endpoint is moved, etc.).

In still at least one embodiment, as shown at 234, the vulnerability management system 120 may recommend specific security controls/policies be deployed in the cloud, perimeter, or core of the enterprise network 110 via network security infrastructure 130 in order to lower a vulnerability score or limit exposure to the threats. In various embodiments, such recommendations could include, but not be limited to, security-related ACLs, redirection of flows from vulnerable endpoints to cloud protection systems, such as a SASE deep-packet inspection firewall in the cloud, and/or any other applicable recommendation. In the present example involving endpoint 112-1, for instance, recommendation may be provided that indicates port number 443 should be closed or otherwise blocked via network security infrastructure 130.

Thus, holistically, embodiments herein may help in ranking the actual risk of vulnerabilities from a larger pool of vulnerabilities in the context of the network security infrastructure's ability to defend against a potential attack, allowing security administrators to focus on which critical assets to be fixed first, for which vulnerabilities the network security infrastructure may not offer (sufficient) protection.

Accordingly, through embodiments herein, vulnerability management system 120 may provide for evaluating how well enterprise network 110 and network security infrastructure 130 may be configured to protect endpoints 112-1-112-N by adjusting vulnerability scores to more realistic values that consider network security policies 116 and security mechanisms provided via network security infrastructure to protect detected vulnerabilities from being triggered for endpoints 112-1-112-N. Using a consolidation of knowledge, vulnerability management system 120 may provide a refined and more realistic view of the vulnerability of an endpoint, thereby allowing a SecOps team to plan a patching strategy accordingly. Thus, updated vulnerability scoring as facilitated by vulnerability management system 120 can help administrators to prioritize patching efforts, security control/policy efforts, etc.

In contrast with current vulnerability management systems, vulnerability scores as determined in current systems are based on either security posture data from an endpoint itself (EDR data) or from a network scanner. Such current systems do not take into account any contextual security protection that is offered by the surrounding infrastructure for an endpoint. Rather, current systems typically rely on scanner data to determine a vulnerability score for an endpoint. However, such scanner techniques do not know (and cannot know) if endpoints are or are not potentially exposed to vulnerabilities-current systems are simply scanning for open ports, etc. Even if current scanner systems may detect an open port that has a vulnerability, current scanner systems do not know if or how the endpoint/host may be vulnerable at the application layer to different types of attacks.

In contrast, vulnerability management system 120 as provided in accordance with techniques herein operates to combine an infrastructure's security capabilities with what a scanner reports, along with classification capabilities of the vulnerability management system and topology information for the network such that a base or current vulnerability score for an endpoint/host can be adjusted in light of the network security infrastructure's ability to defend or protect the endpoint/host from a threat.

Further, with regard to potential threats that may be present within enterprise network 110 (e.g., within a network segment), knowledge provided for vulnerability management system 120 that certain security services are in place to protect a host can provide a more refined picture of the actual vulnerability that may be present for the host. By combining what security protection knowledge can be determined from the network by vulnerability management system 120, a more accurate picture of the relative vulnerability of each host can be determined in accordance with embodiments herein.

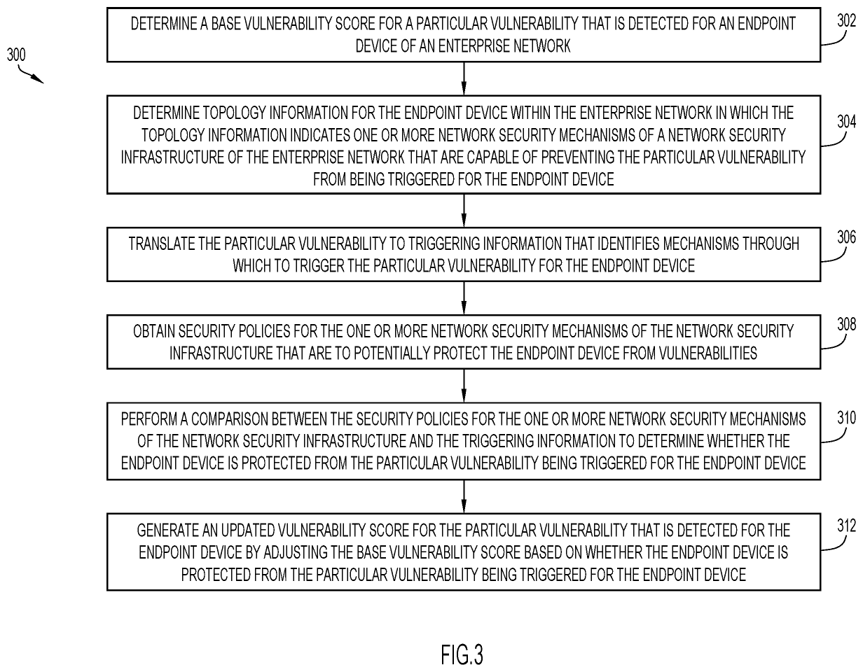

Referring to FIG. 3, FIG. 3 is a flow chart depicting a method 300 according to an example embodiment. In at least one embodiment, method 300 may be associated with operations that may be utilized to facilitate vulnerability management for a network based on network infrastructure security context, according to an example embodiment. In at least one embodiment, method 300 may be performed by a vulnerability management system, such as vulnerability management system 120 via control logic 122, as shown in FIGS. 1 and 2.

At 302, the method may include determining (by the vulnerability management system) a base vulnerability score for a particular vulnerability that is detected for an endpoint device of an enterprise network. At 304, the method may include determining topology information for the endpoint device within the enterprise network in which the topology information indicates one or more network security mechanisms of a network security infrastructure of the enterprise network that are capable of preventing the particular vulnerability from being triggered for the endpoint device. At 306, the method may include translating the particular vulnerability to triggering information that identifies mechanisms through which to trigger the particular vulnerability for the endpoint device.

At 308, the method may include obtaining security policies for the one or more network security mechanisms of the network security infrastructure that are to potentially protect the endpoint device from vulnerabilities and, at 310, the method may include performing a comparison between the security policies for the one or more network security mechanisms of the network security infrastructure and the triggering information to determine whether the endpoint device is protected from the particular vulnerability being triggered for the endpoint device.

At 312, the method may include generating an updated vulnerability score for the particular vulnerability that is detected for the endpoint device by adjusting the base vulnerability score based on whether the endpoint device is protected from the particular vulnerability being triggered for the endpoint device. In one instance, generating the updated vulnerability score includes decreasing the base vulnerability score based on determining that the endpoint is protected by the one or more network security mechanisms of the network security infrastructure (e.g., decreased in proportion to an amount of protection provided via the network security infrastructure). In one instance, generating the updated vulnerability score includes increasing the base vulnerability score based on determining that the endpoint is not protected by the one or more network security mechanisms of the network security infrastructure (e.g., increased in proportion to an amount of protection not provided via the network security infrastructure).

In at least one embodiment, although not shown in FIG. 3, the updated vulnerability score can be provided to a SecOps team, a network administrator, and/or the like to facilitate patching the vulnerability, updating the configuration of the network security infrastructure, or the like in order to mitigate or otherwise prevent the vulnerability from being triggered for the endpoint. In one instance, a priority for performing such patching, updating, etc. can be based on the value of the updated vulnerability score.

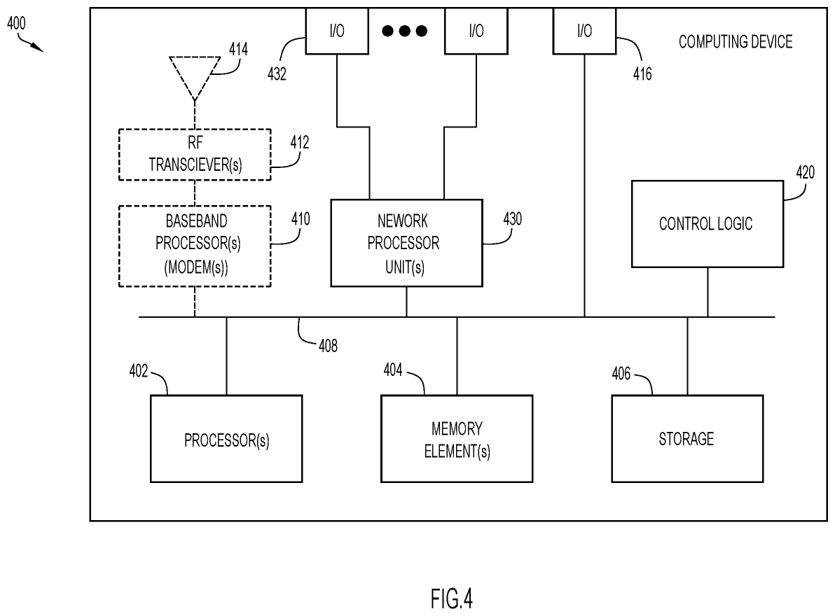

Referring to FIG. 4, FIG. 4 illustrates a hardware block diagram of a computing device 400 that may perform functions associated with operations discussed herein in connection with the techniques depicted via FIGURES as provided herein. In various embodiments, a computing device or apparatus, such as computing device 400 or any combination of computing devices 400, may be configured as any entity/entities as discussed for the techniques depicted in connection with operations illustrated/discussed for various embodiments herein, such vulnerability management system 120, network management system 114, one or more security mechanisms of network security infrastructure 130, endpoints 112-1-112-N discussed herein, and/or any other elements/functions/nodes discussed herein.

In at least one embodiment, the computing device 400 may be any apparatus that may include one or more processor(s) 402, one or more memory element(s) 404, storage 406, a bus 408, one or more network processor unit(s) 430 interconnected with one or more network input/output (I/O) interface(s) 432, one or more I/O interface(s) 416, and control logic 420. In various embodiments, instructions associated with logic for computing device 400 can overlap in any manner and are not limited to the specific allocation of instructions and/or operations described herein.

For embodiments in which computing device 400 may be implemented as any device capable of wireless communications, computing device 400 may further include at least one baseband processor or modem 410, one or more radio RF transceiver(s) 412 (e.g., any combination of RF receiver(s) and RF transmitter(s)), one or more antenna(s) or antenna array(s) 414.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory element(s) 404 (or vice versa) or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 430 may enable communication between computing device 400 and other systems, entities, etc., via network I/O interface(s) 432 (wired and/or wireless) to facilitate operations discussed for various embodiments described herein. In various embodiments, network processor unit(s) 430 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 432 can be configured as one or more Ethernet port(s), Fibre Channel ports, any other I/O port(s), and/or antenna(s)/antenna array(s) now known or hereafter developed. Thus, the network processor unit(s) 430 and/or network I/O interface(s) 432 may include suitable interfaces for receiving, transmitting, and/or otherwise communicating data and/or information (wired and/or wirelessly) in a network environment.

I/O interface(s) 416 may allow for input and output of data and/or information with other entities that may be connected to computing device 400. For example, I/O interface(s) 416 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 400 is implemented as a wireless device or any apparatus capable of wireless communications, the RF transceiver(s) 412 may perform RF transmission and RF reception of wireless signals via antenna(s)/antenna array(s) 414, and the baseband processor or modem 410 performs baseband modulation and demodulation, etc. associated with such signals to enable wireless communications for computing device 400.

In various embodiments, control logic 420, can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include determining a base vulnerability score for a particular vulnerability that is detected for an endpoint device of an enterprise network; determining topology information for the endpoint device within the enterprise network, wherein the topology information indicates one or more network security mechanisms of a network security infrastructure of the enterprise network that are capable of preventing the particular vulnerability from being triggered for the endpoint device; translating the particular vulnerability to triggering information that identifies mechanisms through which to trigger the particular vulnerability for the endpoint device; obtaining security policies for the one or more network security mechanisms of the network security infrastructure that are to potentially protect the endpoint device from vulnerabilities; performing a comparison between the security policies for the one or more network security mechanisms of the network security infrastructure and the triggering information to determine whether the endpoint device is protected from the particular vulnerability being triggered for the endpoint device; and generating an updated vulnerability score for the particular vulnerability that is detected for the endpoint device by adjusting the base vulnerability score based on whether the endpoint device is protected from the particular vulnerability being triggered for the endpoint device.

In one instance, generating the updated vulnerability score includes decreasing the base vulnerability score based on determining that the endpoint is protected by the one or more network security mechanisms of the network security infrastructure. In one instance, generating the updated vulnerability score includes increasing the base vulnerability score based on determining that the endpoint is not protected by the one or more network security mechanisms of the network security infrastructure.

In various instances, the triggering information identifies at least one of: one or more port numbers through which to trigger the particular vulnerability that is detected for the endpoint; one or more internet protocol (IP) addresses through which to trigger the particular vulnerability that is detected for the endpoint; or one or more function calls through which to trigger the particular vulnerability that is detected for the endpoint.

In one instance, the method may further include obtaining priority information that identifies an asset importance of the endpoint. In one instance, generating the updated vulnerability score includes generating a first updated vulnerability score for the particular vulnerability that is detected for the endpoint device by adjusting the base vulnerability score based on determining whether the endpoint device is protected from the particular vulnerability being triggered for the endpoint device and applying a weight to the first vulnerability score based on the priority information to generate a second updated vulnerability score.

In one instance, the translating is based on vulnerability information obtained from one or more vulnerability information sources in which the triggering information identifies the mechanisms through which the vulnerability can be triggered for the endpoint. The method can be performed for a plurality of endpoints of the enterprise network for which one or more other vulnerabilities are detected.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of, ‘one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X. Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
determining a base vulnerability score for a particular vulnerability that is detected for an endpoint device of an enterprise network;
determining topology information for the endpoint device within the enterprise network, wherein the topology information indicates one or more network security mechanisms of a network security infrastructure of the enterprise network that are capable of preventing the particular vulnerability from being triggered for the endpoint device;
translating the particular vulnerability to triggering information that identifies mechanisms through which to trigger the particular vulnerability for the endpoint device;
obtaining security policies for the one or more network security mechanisms of the network security infrastructure that are to potentially protect the endpoint device from vulnerabilities;
performing a comparison between the security policies for the one or more network security mechanisms of the network security infrastructure and the triggering information to determine whether the endpoint device is protected from the particular vulnerability being triggered for the endpoint device; and
generating an updated vulnerability score for the particular vulnerability that is detected for the endpoint device by adjusting the base vulnerability score based on whether the endpoint device is protected from the particular vulnerability being triggered for the endpoint device.

2. The method of claim 1, wherein generating the updated vulnerability score includes decreasing the base vulnerability score based on determining that the endpoint device is protected by the one or more network security mechanisms of the network security infrastructure.

3. The method of claim 1, wherein generating the updated vulnerability score includes increasing the base vulnerability score based on determining that the endpoint device is not protected by the one or more network security mechanisms of the network security infrastructure.

4. The method of claim 1, wherein the triggering information identifies at least one of:
one or more port numbers through which to trigger the particular vulnerability that is detected for the endpoint device;
one or more internet protocol (IP) addresses through which to trigger the particular vulnerability that is detected for the endpoint device; or
one or more function calls through which to trigger the particular vulnerability that is detected for the endpoint device.

5. The method of claim 1, further comprising:
obtaining priority information that identifies an asset importance of the endpoint device.

6. The method of claim 5, wherein generating the updated vulnerability score includes generating a first updated vulnerability score for the particular vulnerability that is detected for the endpoint device by adjusting the base vulnerability score based on determining whether the endpoint device is protected from the particular vulnerability being triggered for the endpoint device and applying a weight to the first updated vulnerability score based on the priority information to generate a second updated vulnerability score.

7. The method of claim 1, wherein the translating is based on vulnerability information obtained from one or more vulnerability information sources in which the triggering information identifies the mechanisms through which the particular vulnerability that is detected for the endpoint device can be triggered for the endpoint device.

8. The method of claim 1, wherein the method is performed for a plurality of endpoint devices of the enterprise network for which one or more other vulnerabilities are detected.

9. One or more non-transitory computer readable storage media encoded with instructions that, when executed by a processor, cause the processor to perform operations, comprising:
determining a base vulnerability score for a particular vulnerability that is detected for an endpoint device of an enterprise network;
determining topology information for the endpoint device within the enterprise network, wherein the topology information indicates one or more network security mechanisms of a network security infrastructure of the enterprise network that are capable of preventing the particular vulnerability from being triggered for the endpoint device;
translating the particular vulnerability to triggering information that identifies mechanisms through which to trigger the particular vulnerability for the endpoint device;
obtaining security policies for the one or more network security mechanisms of the network security infrastructure that are to potentially protect the endpoint device from vulnerabilities;
performing a comparison between the security policies for the one or more network security mechanisms of the network security infrastructure and the triggering information to determine whether the endpoint device is protected from the particular vulnerability being triggered for the endpoint device; and
generating an updated vulnerability score for the particular vulnerability that is detected for the endpoint device by adjusting the base vulnerability score based on whether the endpoint device is protected from the particular vulnerability being triggered for the endpoint device.

10. The media of claim 9, wherein the triggering information identifies at least one of:
one or more port numbers through which to trigger the particular vulnerability that is detected for the endpoint device;
one or more internet protocol (IP) addresses through which to trigger the particular vulnerability that is detected for the endpoint device; or
one or more function calls through which to trigger the particular vulnerability that is detected for the endpoint device.

11. The media of claim 9, wherein the triggering information identifies at least one of:
one or more port numbers through which to trigger the particular vulnerability that is detected for the endpoint device;
one or more internet protocol (IP) addresses through which to trigger the particular vulnerability that is detected for the endpoint device; or
one or more function calls through which to trigger the particular vulnerability that is detected for the endpoint device.

12. The media of claim 9, wherein the operations are performed for a plurality of endpoint devices of the enterprise network for which one or more other vulnerabilities are detected.

13. A system comprising:
at least one memory element for storing data; and
at least one processor for executing instructions associated with the data, wherein executing the instructions causes the system to perform operations, comprising:
determining a base vulnerability score for a particular vulnerability that is detected for an endpoint device of an enterprise network;
determining topology information for the endpoint device within the enterprise network, wherein the topology information indicates one or more network security mechanisms of a network security infrastructure of the enterprise network that are capable of preventing the particular vulnerability from being triggered for the endpoint device;
translating the particular vulnerability to triggering information that identifies mechanisms through which to trigger the particular vulnerability for the endpoint device;
obtaining security policies for the one or more network security mechanisms of the network security infrastructure that are to potentially protect the endpoint device from vulnerabilities;
performing a comparison between the security policies for the one or more network security mechanisms of the network security infrastructure and the triggering information to determine whether the endpoint device is protected from the particular vulnerability being triggered for the endpoint device; and
generating an updated vulnerability score for the particular vulnerability that is detected for the endpoint device by adjusting the base vulnerability score based on whether the endpoint device is protected from the particular vulnerability being triggered for the endpoint device.

14. The system of claim 13, wherein generating the updated vulnerability score includes decreasing the base vulnerability score based on determining that the endpoint device is protected by the one or more network security mechanisms of the network security infrastructure.

15. The system of claim 13, wherein generating the updated vulnerability score includes increasing the base vulnerability score based on determining that the endpoint device is not protected by the one or more network security mechanisms of the network security infrastructure.

16. The system of claim 13, wherein the triggering information identifies at least one of:
one or more port numbers through which to trigger the particular vulnerability that is detected for the endpoint device;
one or more internet protocol (IP) addresses through which to trigger the particular vulnerability that is detected for the endpoint device; or
one or more function calls through which to trigger the particular vulnerability that is detected for the endpoint device.

17. The system of claim 13, wherein executing the instructions causes the system to perform further operations, comprising:
obtaining priority information that identifies an asset importance of the endpoint device.

18. The system of claim 17, wherein generating the updated vulnerability score includes generating a first updated vulnerability score for the particular vulnerability that is detected for the endpoint device by adjusting the base vulnerability score based on determining whether the endpoint device is protected from the particular vulnerability being triggered for the endpoint device and applying a weight to the first updated vulnerability score based on the priority information to generate a second updated vulnerability score.

19. The system of claim 13, wherein the translating is based on vulnerability information obtained from one or more vulnerability information sources in which the triggering information identifies the mechanisms through which the particular vulnerability that is detected for the endpoint device can be triggered for the endpoint device.

20. The system of claim 13, wherein the operations are performed for a plurality of endpoint devices of the enterprise network for which one or more other vulnerabilities are detected.
